(19) United States
(12) Patent Application Publication
(10) Pub. No.: US 2005/0048933 A1
(43) Pub. Date: Mar. 3, 2005

(54) Adaptive transmit diversity with quadrant phase constraining feedback

(76) Inventors: Jingxian Wu, Colombia, MO (US); Jinyun Zhang, Cambridge, MA (US); Andreas Molisch, Arlington, MA (US)

Correspondence Address: Patent Department;Mitsubishi Electric Research Laboratories, Inc., 201 Broadway, Cambridge, MA, 02139, US

(21) Appl. No.: 10/720,596

(22) Filed: Nov. 24, 2003

Related U.S. Application Data
(63) Continuation-in-part of application No. 10/648,558, filed on Aug. 25, 2003.

(51) Int. Cl. H04B 7/02

(52) U.S. Cl. 455/101; 455/91

(57) ABSTRACT

A wireless communication system includes a transmitter and a receiver. The transmitter includes multiple groups of transmit antennas. Input symbols are generated and then orthogonal space-time block is encoded to produce a data stream for each group of transmit antennas. Each data stream is adaptively linear space encoded to produce an encoded signal for each transmit antenna of each group according to feedback information for the group. The receiver includes a single receive antenna, a module for measuring a phase of a channel impulse response for each transmit antenna. The feedback information is determined independently for each group of transmit antennas from the channel impulse responses. The feedback information for each group of transmit antennas is sent to the transmitter.

### RELATED APPLICATION

This application is a continuation-in-part of U.S. patent application Ser. No. 10/648,558, “Adaptive Transmit Diversity with Quadrant Phase Constraining Feedback,” filed on Aug. 25, 2003 by Wu et al.

### FIELD OF THE INVENTION

This invention relates generally to transmit diversity gain in wireless communications networks, and more particularly to maximizing the diversity gain adaptively in transmitters.

### BACKGROUND OF THE INVENTION

The next generation of wireless communication systems is required to provide high quality voice services as well as broadband data services with data rates far beyond the limitations of current wireless systems. For example, high speed downlink packet access (HSDPA), which is endorsed by the 3^{rd} generation partnership project (3GPP) standard for wideband code-division multiple access (WCDMA) systems, is intended to provide data rates up to 10 Mbps or higher in the downlink channel as opposed to the maximum 384 Kbps supported by the enhance data rate for GSM evolution (EDGE), the so-called 2.5G communication standard, see 3GPP: 3GPP TR25.848 v4.0.0, “3GPP technical report: Physical layer aspects of ultra high speed downlink packet access,” March 2001, and ETSI. GSM 05.05, “Radio transmission and reception,” ETSI EN 300 910 V8.5.1, November 2000.

Antenna diversity can increase the data rate. Antenna diversity effectively combats adverse effects of multipath fading in channels by providing multiple replicas of the transmitted signal at the receiver. Due to the limited size and cost of a typical end user device, e.g., a cellular telephone or handheld computer, downlink transmissions favor transmit diversity over receiver diversity.

One of the most common transmit diversity techniques is space-time coding, see Alamouti, “A simple transmit diversity technique for wireless communications,” IEEE J. Select. Area Commun., vol.16, pp.1451-1458, October 1998, Tarokh et al., “Space-time codes for high data rate wireless communication: performance criterion and code construction,” IEEE Trans. Info. Theory, vol.44, pp.744-765, March 1998, Tarokh et al., “Space-time block codes from orthogonal designs,” IEEE Trans. Info. Theory, vol.45, pp.1456-1467, July 1999, and Xin et al., “Space-time diversity systems based on linear constellation preceding,” IEEE Trans. Wireless Commun., vol.2, pp.294-309, March 2003.

With space-time coding, data symbols are encoded in both the time domain (transmission intervals) and the space domain (transmit antenna array). For systems with exactly two transmit antennas, Alamouti et. al. describe orthogonal space-time block code (STBC). Full diversity order is achieved with simple algebraic operations.

Space-time trellis coding exploits the full potential of multiple antennas by striving to maximize both the diversity gains and coding gains of the system. Better performance is achieved at the cost of relatively higher encoding and decoding complexity.

The above techniques are designed under the assumption that the transmitter has no knowledge of the fading channels. Thus, those techniques can be classified as having open loop transmit diversity.

System performance can be further improved when some channel information is available at the transmitter from feedback information from the receiver. Those systems are classified as having closed loop transmit diversity. The feedback information can be utilized in transmit diversity systems to maximize the gain in the receiver, see Jongren et al., “Combining beamforming and orthogonal space-time block coding,” IEEE Trans. Info. Theory, vol.48, pp.611-627, March 2002, Zhou et al., “Optimal transmitter eigen-beamforming and space-time block coding based on channel mean feedback,” IEEE Trans. Signal Processing, vol. 50, pp.2599-2613, October 2002, Rohani et al., “A comparison of base station transmit diversity methods for third generation cellular standards,” Porc. IEEE Veh. Techno. Conf. VTC'99 Spring, pp.351-355, May 1999, Derryberry et al., “Transmit diversity in 3G CDMA systems,” IEEE Commun. Mag., vol.40, pp. 68-75, April 2002, Lo, “Maximum ratio transmission,” IEEE Trans. Commun., vol.47, pp. 1458-1461, October 1999, Huawe, “STTD with adaptive transmitted power allocation,” TSGR1-02-0711, May, 2002, and Horng et al., “Adaptive space-time transmit diversity for MIMO systems,” Proc. IEEE Veh. Techno. Conf VTC'03 Spring, pp. 1070-1073, April 2003.

The space-time block coding can be combined with linear optimum beamforming. Linear encoding matrices can be optimized based on the feedback information of the fading channels. Transmit adaptive array (TxAA) is another close loop transmit diversity system with the transmitted symbols encoded only in the space domain. Increased performance can be achieved, provided the fading channel vector is known to the transmitter. The concept of space encoded transmit diversity can be generalized as maximal ratio transmission (MRT).

All of the above closed loop systems require the feedback information to be M×N complex-valued matrices, where M and N are respectively the number of antennas at the transmitter and receiver. The matrix elements are either the channel impulse response (CIR), or statistics of the CIR, e.g., mean or covariance. Because the feedback matrices contain 2MN real-valued scalars, considerable bandwidth is consumed by the feedback information in the reverse link from the receiver to the transmitter.

To overcome this problem, suboptimum methods with less feedback information are possible. Adaptive space-time block coding (ASTTD) uses a real-valued vector made up of power ratios of the fading channels as feedback information. There, the feedback information is used to adjust the power of each transmission antenna. That technique still consumes a large number of bits.

Therefore, it is desired to maximize transmit diversity gain while reducing the number of bits that are fed back to the transmitter.

### SUMMARY OF THE INVENTION

The invention provides an adaptive transmit diversity scheme with simple feedback for a wireless communication systems.

It is an object of the invention to achieve better system performance with less feedback information and less computations than conventional transmit diversity methods.

With simple linear operations at both the transmitter and receiver, the method requires only one bit of feedback information for systems with two antennas (M=2) at the transmitter and one antenna at the receiver.

When there are more antennas at the transmitter (M>2), the number of feedback bits is 2(M−1) bits. This is still significantly less than the number of bits required by most conventional closed loop transmit diversity techniques.

When the indicated quadrant phase constraining method is combined with orthogonal space time block code, the amount of feedback information can be further reduced. For systems with three and four transmit antennas, the amount of feedback can be as few as one and two bits, respectively.

The computational complexity of the invented method is much lower compared with optimum quantized TxAA closed loop technique with the same amount of feedback.

In addition, the method outperforms some closed loop transmit diversity techniques that have more information transmitted in the feedback channel.

### BRIEF DESCRIPTION OF THE DRAWINGS

FIG. 1 is a block diagram of a system with diversity gain according to the invention;

FIG. 2 is a diagram of four quadrants of a coordinate system for indicating quadrant phase constraining according to the invention;

FIG. 3 is a diagram of a normalized coordinate system with the phase of the reference signal on the x-axis of the coordinate system according to the invention; and

FIG. 4 is a block diagram of a system combining orthogonal space time block code and quadrant phase constraining according to the invention.

### DETAILED DESCRIPTION OF THE PREFERRED EMBODIMENT

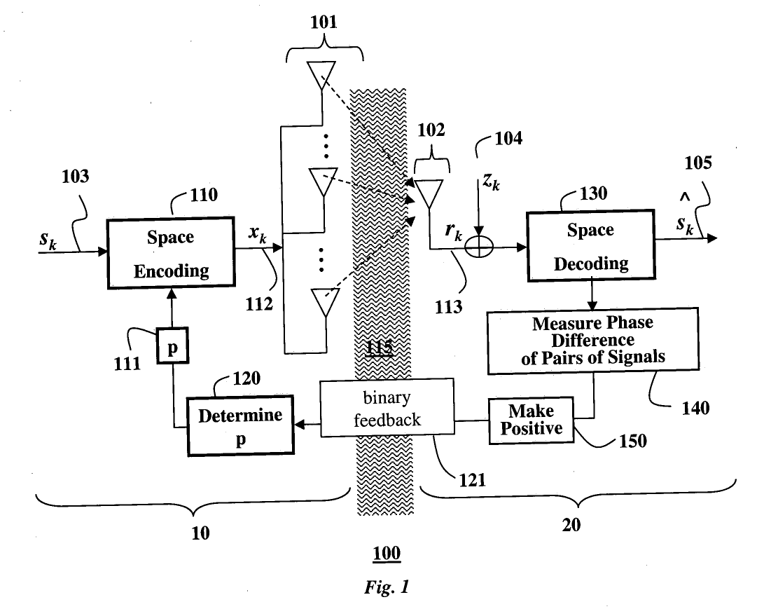

FIG. 1 shows a baseband representation of a diversity system 100 according to our invention. Our system has M antennas 101 at a transmitter 10, for example, a base station, and one antenna 102 at a receiver 20, e.g., a cellular telephone.

At a time instant k, a modulated symbol sₖ 103 is linearly encoded 110 at the transmitter in a space domain according to a space encoding vector 111
pₖ=[p₁(k), p₂(k), . . . , p_{M}(k)]εC^{1×M}.

The encoded transmit data 112 are xₖ=[x₁(k), x₂(k), . . . , x_{M}(k)]=pₖ·sₖ, with xₘ(k) being transmitted at the m^{th} transmit antenna 101.

In our adaptive transmit diversity method, the space encoding vector pₖ 111 is determined 120 at the transmitter according to feedback information 121 determined from space decoding 130 of the received signal 105 at the receiver.

Specifically, the feedback information 121 relates to phase differences between pairs of received signals in a fading transmission channel 115. It is desired to minimize the phase difference between signals, so that diversity gain is maximized at the receiver. Furthermore, it is desired to minimize the number of bits required to indicate the phase difference. It is also desired to reduce the amount of computation involved generating the feedback information at the receiver 20.

The received signal is a sum of the propagation signals from all the transmit antennas subject to the channel impulse responses, plus additive white Gaussian noise (AWGN) 104 with variance N₀/2 per dimension. At the receiver, samples rₖ 113 of the received signal Rₓ can be expressed by

$$\begin{matrix}r ( k ) = \sqrt{\frac{{E}_{s}}{M}} \cdot {x}_{k} {h}_{k} + {z}_{k} , \\ = \sqrt{\frac{{E}_{s}}{M}} \cdot ( {p}_{k} {h}_{k} ) \cdot {s}_{k} + {z}_{k} ,\end{matrix} \qquad ( 1 )$$

where Eₛ is the sum of the transmit energy of all the transmit antennas, M is the number of antennas, zₖ is the additive noise 104. The time-varying channel impulse response (CIR) of each fading channel is
hₖ=[h₁(k), h₂(k), . . . , h_{M}(k)]^{T}εC^{M×1},
where hₘ(k) is the CIR for the fading channel between the m^{th} transmit antenna and the receive antenna, and (•)^{T} denotes a matrix transpose.

With the system model defined by equation (1), an optimum space encoding vector \hat{p}ₖ for maximizing the output SNR is

$${\hat{p}}_{k} = \frac{{h}_{k}^{H}}{{h}_{k} {h}_{k}^{H}} , \qquad ( 2 )$$

where (•)^{H} denotes a Hermitian matrix operator. This scheme is called transmit adaptive array (TxAA). However, forming the optimum space encoding vector requires a complete of understanding of the CIR vector hₖ, which contains 2M real scalar values. Hence, it is impractical to implement the TxAA scheme in practical systems where limited resources are allocated to the feedback channel.

To reduce the amount of feedback information, an optimum quantized feedback scheme is described for TxAA. The space encoding vector is obtained from an exhaustive searching algorithm as follows

$${\hat{p}}_{k} = {arg min}_{{p}_{k} ∈ P} {p}_{k} {h}_{k} {h}_{k}^{H} {p}_{k}^{H} \qquad ( 3 )$$

where P is the set of all the possible quantized space encoding vectors. The set contains 2^{b(M-1)} possible vectors for systems with b bits quantization and M transmit antennas. In order to find the optimum quantized feedback vector \hat{p}ₖ, the receiver must exhaustively determine the values of pₖhₖhₖ^{H}pₖ^{H} for all the possible 2^{b(M-1)} encoding vectors before the optimum encoding vector can be selected.

Each computation of the cost function involves approximately M² complex multiplications. Therefore, the total amount of computational complexity incurred by the feedback information alone is in the order of O(2^{b(M-1)}×M²), which increases exponentially with the number of transmit antennas and is quite considerable when the number of antennas is larger than two.

To balance the system performance, the size of feedback information, and the computational complexity of the system, the adaptive transmit diversity method according to our invention uses a quadrant phase constraining method to determine the feedback information. Thus, both the amount of feedback and computation complexity can be greatly reduced.

Method Description

The present adaptive transmit diversity method is described first for the simplest system with two transmit antennas and one receive antenna. In this simple case, exactly one bit of feedback information is required to generate the space encoding vector 111 used by the space encoding 110. In a general method for systems with M>2 transmit antennas, it takes 2(M−1) bits of feedback information to determine 120 the space encoding vector 111.

Systems with Two Transmit Antennas

For systems with two transmit antennas, we define our space encoding vector 111 as
pₖ=[1, (−1)^{b}^{ₖ}], (4)
where bₖε{0, 1} is the quantized binary feedback information 121 sent out from the receiver. The single feedback bit bₖ, either zero or one, is based on an estimated phase shift in the CIR hₖ as follows,

$${b}_{k} = \{ \begin{matrix}0 , & if ℜ \{ {h}_{1} ( k ) {h}_{2}^{*} ( k ) \} > 0 , \\ 1 , & otherwise ,\end{matrix} \qquad ( 5 )$$

where hₘ(k) is the time-varying channel impulse response, (•)* denotes a complex conjugate, and the operation [symbol] (•) returns the real part of the operand. In other words, the bit is zero if the product of the CIR of one channel with the complex conjugate of the CIR of the other channel is positive, and one otherwise, and thus, the space encoding vector p 111 is either [1,1] or [1, −1], respectively.

With the definition of the space encoding vector pₖ in equation (3), the transmitted signal vector 112 is xₖ=[sₖ, (−1)^{b}^{ₖ}sₖ]. Replacing the vector xₖ in equation (1), we have the received sample as

$$r ( k ) = \sqrt{\frac{{E}_{s}}{2}} [ {h}_{1} ( k ) + {h}_{2} ( k ) {( - 1 )}^{{b}_{k}} ] \cdot {s}_{k} + {z}_{k} . \qquad ( 6 )$$

In receivers with coherent detection, the received sample r(k) is multiplied by (pₖhₖ)^{H}=h₁*(k)+h₂*(k)(−1)^{b}^{ₖ} to form the decision variable y(k),

$$\begin{matrix}y ( k ) = ( {h}_{1}^{*} ( k ) + {( - 1 )}^{{b}_{k}} {h}_{2}^{*} ( k ) ) \cdot {r}_{k} , \\ = \sqrt{\frac{{E}_{s}}{2}} [ {\vert {h}_{1} ( k ) \vert}^{2} + {\vert {h}_{2} ( k ) \vert}^{2} + {( - 1 )}^{{b}_{k}} \cdot 2 ℜ \{ {h}_{1} ( k ) {h}_{2}^{*} ( k ) \} ] {s}_{k} + {v}_{k} ,\end{matrix} \qquad ( 7 )$$

where vₖ=[h₁*(k)+(−1)^{b}^{ₖ}h₂*(k)]·zₖ is the noise component of the decision variable. The variance of noise component vₖ is
σᵥ²=[|h₁(k)|²+|h₂(k)|²+(−1)^{b}^{ₖ}·2 [symbol] {h₁(k)h₂*(k)}]·N₀. (8)

It can be seen from equation (5) that
(−1)^{b}^{ₖ}·2 [symbol] {h₁(k)h₂*(k)}=2| [symbol] {h₁(k)h₂*(k)}|, (9)
thus the instantaneous output SNR γ at the receiver can be written as

$$\begin{matrix}γ = \frac{{γ}_{0}}{2} \cdot [ \vert {h}_{1} ( k ) {\vert}^{2} + \vert {h}_{2} ( k ) {\vert}^{2} + 2 \vert ℜ \{ {h}_{1} ( k ) {h}_{2}^{*} ( k ) \} \vert ] , & ( 10 ) \\ = {γ}_{0} \cdot ( {g}_{c} + {g}_{b} ) , & ( 11 )\end{matrix}$$

where

$${γ}_{0} = \frac{{E}_{s}}{{N}_{0}}$$

is the SNR without diversity. The conventional diversity gain g_{c} and the feedback diversity gain g_{b} are defined as

$${g}_{c} = \frac{1}{2} [ {\vert {h}_{1} ( k ) \vert}^{2} + {\vert {h}_{2} ( k ) \vert}^{2} ] , \qquad ( 12 )$$

g_{b}=2| [symbol] {h₁(k)h₂*(k)}|. (13)
The conventional diversity gain g, is the same as the diversity gain of the orthogonal space-time block coding (STBC), while the feedback diversity gain g_{b} is the extra diversity gain contributed by the binary feedback information 121.

From the above equations, we can see that with only one bit bₖ of feedback information 121 in a closed loop system, the output SNR of our transmission diversity scheme, which also considers feedback diversity gain, is always better than when just the orthogonal STBC gain is considered in an open loop system, although the transmitted signals are only encoded in the space domain.

Systems with More than Two Transmit Antennas

The process described above is for systems with two transmit antennas. If there are more than two antennas (M>2) at the transmitter, then a modified transmit diversity method with 2(M−1) bits feedback information is used.

For systems with m>2 transmit antennas, we define the space encoding vector 111 as

$${p}_{k} = [ \begin{matrix}1 & exp [ \frac{ⅈ \cdot {q}_{2} ( k ) π}{2} ] & ⋯ & exp [ \frac{ⅈ \cdot {q}_{M} ( k ) π}{2} ]\end{matrix} ] , \qquad ( 14 )$$

where i²=−1, and qₘ(k)ε{0, 1, 2, 3} is the feedback information from the receiver, for m=2, 3, . . . , M. For consistence of representation, we let q₁(k)=0, for ∀k.

By such definitions, each qₘ(k) contains two bits of information, and there are a total of 2(M−1) bits of feedback information used to form the space encoding vector Pₖ. Combining equations (1) and (14), we can write the received sample r(k) as

$$r ( k ) = \sqrt{\frac{{E}_{s}}{M}} \{ {\sum }_{m = 1}^{M} exp [ \frac{ⅈ \cdot {q}_{m} ( k ) π}{2} ] {h}_{m} ( k ) \} \cdot {s}_{k} + {z}_{k} . \qquad ( 15 )$$

At the decoder 130, the decision variable y(k) is obtained by multiplying the received sample r(k) with (pₖhₖ)^{H}. This can be written as

$$\begin{matrix}y ( k ) = \sqrt{\frac{{E}_{s}}{M}} {\vert {\sum }_{m = 1}^{M} exp [ \frac{ⅈ \cdot {q}_{m} ( k ) π}{2} ] {h}_{m} ( k ) \vert}^{2} \cdot {s}_{k} + {v}_{k} , \\ = \sqrt{\frac{{E}_{s}}{M}} ( {g}_{c} + {g}_{b} ) \cdot {s}_{k} + {v}_{k} ,\end{matrix} \qquad ( 16 )$$

where vₖ=(pₖhₖ)^{H}·zₖ is the noise component with variance |pₖhₖ|²·N₀, and the conventional and feedback diversity gains g_{c} and g_{b} are defined respectively as

$$\begin{matrix}{g}_{c} = \frac{1}{M} {\sum }_{m = 1}^{M} {\vert {h}_{m} ( k ) \vert}^{2} , and & ( 17 ) \\ {g}_{b} = \frac{2}{M} {\sum }_{m = 1}^{M} {\sum }_{n = m + 1}^{M} ℜ \{ {h}_{m} ( k ) {h}_{n}^{*} ( k ) exp [ ⅈ \cdot π \frac{{q}_{m} ( k ) - {q}_{n} ( k )}{2} ] \} . & ( 18 )\end{matrix}$$

In the equations above, the conventional diversity gain g_{c} is fixed for a certain value of M, while the feedback diversity gain is maximized by appropriately selecting the feedback information based on qₘ(k).

With the 2(M−1) bits of information, we can maximize g_{b} by selecting qₘ(k) such that all the summed elements of g_{b} are positive. One of the summed element of g_{b} can be expressed as

$$ℜ \{ {h}_{m} ( k ) {h}_{n}^{*} ( k ) exp [ ⅈ \cdot π \frac{{q}_{m} ( k ) - {q}_{n} ( k )}{2} ] \} = \vert {h}_{m} ( k ) \vert \vert {h}_{n} ( k ) \vert cos ( Δ {θ}_{mn} ) , \qquad ( 19 )$$

where θₘε[0, 2π) is the phase of hₘ(k)

The terms in equation (19) are positive when the following condition is satisfied
|Δθₘₙ|≦π/2, for ∀m≠n. (20)
In words, the absolute difference in phase between two signals is less than 90 degrees.

To satisfy this maximization condition in equation (20), we adjust qₘ(k) so that the phases

$${θ}_{m} + \frac{{q}_{m} ( k )}{2} π ,$$

for m=1, 2, . . . , M, for all received signals are within 90 degrees of each other. We call this method a quadrant phase constraining method.

Without loss of generality, we keep the phase θ₁ of the signal in the first sub-channel n₁(k) unchanged. We call this the reference phase of the reference signal. The reference phase can be selected arbitrarily from any of the M transmit antennas, or the CIR with the highest power.

Now, the goal is to make the phases difference between all the signals less than

$$\frac{π}{2} ,$$

or constraining all the shifted phases to a quadrant phase sector, i.e., a sector of 90 degrees.

Therefore, the phases θₘ of the signals in all other sub-channels need to be rotated counter-clockwise at the transmitter

$$\frac{{q}_{m} ( k )}{2} π$$

so that the absolute phase difference is less than 90 degrees. By such means, only two bits of information are required to form each qₘ(k).

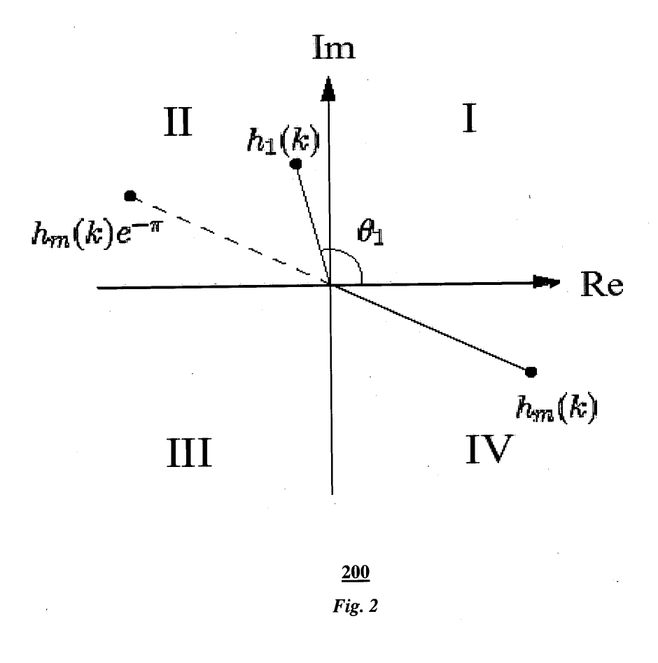

One method to fulfill the quadrant phase constraining condition is to put all the phases in the same coordinate quadrant as the reference phase. As shown in FIG. 2, we label four quadrants I-IV of the Cartesian coordinate system for real (Re) and imaginary (Im) numbers. The quadrant number of any angle φε[0, 2π) is

$$⌈ \frac{2 ϕ}{π} ⌉ ,$$

where ┌ [symbol] ┐ denotes rounding up to the nearest integer.

With the above analyses, the feedback information qₘ(k) for m=2, 3, . . . , M is determined at the receiver based on the phase difference between any pair of received signals.

$${q}_{m} ( k ) = ⌈ \frac{2 {θ}_{1}}{π} ⌉ - ⌈ \frac{2 {θ}_{m}}{π} ⌉ . \qquad ( 21 )$$

The example 200 in FIG. 2 has θ₁ in quadrant II, and θₘ in quadrant IV. With equation (21), we obtain qₘ(k)=−2, which corresponds to rotate θₘ by π radians clockwise (180°), and the rotated phase

$${θ}_{m} - \frac{{q}_{m} ( k )}{2} π$$

is now in quadrant II.

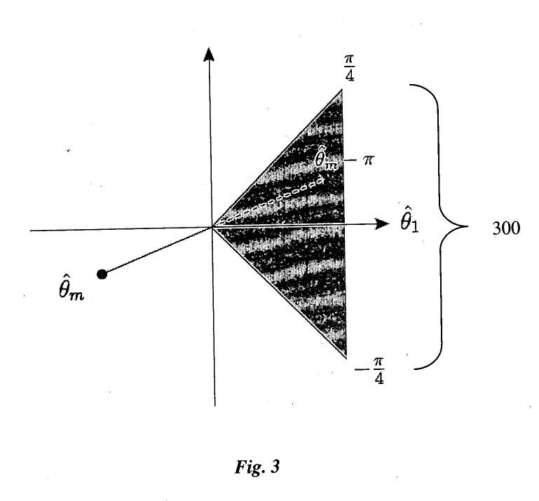

Alternatively, all the phases are put in a 90 degree sector 300 centered around the reference phase as shown in FIG. 3. We normalize all the phases with respect to the reference phase as follows \tilde{θ}ₘ=θₘ−θ₁+2lπ, where the integer l is chosen such that the normalized phase \tilde{θ}ₘ is in the range of [0, 2π). The normalized phase \tilde{θ}ₘ is rotated counter-clockwise by the angle of

$${q}_{m} \frac{π}{2} ,$$

so that the rotated angle

$${\tilde{θ}}_{m} + {q}_{m} \frac{π}{2}$$

is in the quadrant phase sector from [−π/4,π/4] of the coordinate system as shown in FIG. 3. Following the description above, we can compute the feedback information qₘ as

$${q}_{m} = \{ \begin{matrix}4 - ⌊ \frac{{\tilde{θ}}_{m} + π / 4}{π / 2} ⌋ , & {\tilde{θ}}_{m} ∈ [ \frac{π}{4} , \frac{7 π}{4} ] , \\ 0 , & otherwise ,\end{matrix} ,$$

where └ [symbol] ┘ returns the nearest smaller integer. An example is shown in FIG. 3, where \tilde{θ}ₘ=9π/8.

We can determine that qₘ=2, and the corresponding rotated angle is

$${\tilde{θ}}_{m} - {q}_{m} \frac{π}{2} = π / 8 ,$$

which is in the quadrant phase sector of

$$[ - \frac{π}{4} , \frac{π}{4} ]$$

of the coordinate system.

By performing the same operations one by one to all of the normalized phases, the rotated phases are confined to the same quadrant phase sector, and the non-negativity of each summed element of the diversity gain g_{b} can be guaranteed.

This method achieves the non-negativity of the feedback diversity gained by constraining all the rotated phases of the CIRs of one group of transmit antennas in a quadrant phase sector of π/2. Hence, we call it quadrant phase constraining method.

Because the feedback value of qₘ is determined independently for each of the transmit antennas, the computational complexity of our method increases linearly with the number of transmit antennas, as opposed to the exponentially increased complexity of the prior art optimum quantization method.

The feedback information computed from the quadrant phase constraining method guarantees that all the elements described in Equation (19) are positive for ∀m·n, and the maximized feedback diversity gain g, contributed by the feedback information is written as

$${g}_{b} = \frac{2}{M} {\sum }_{m = 1}^{M} {\sum }_{n = m + 1}^{M} \vert {h}_{m} ( k ) \vert \vert {h}_{n} ( k ) \vert \vert cos ( Δ {θ}_{m n} ) \vert . \qquad ( 22 )$$

Combining equations (16), (17) and (22), yields the output SNR γ at the detector receiver as

$$\begin{matrix}γ = {γ}_{0} \cdot [ \frac{1}{M} {\sum }_{m = 1}^{M} {\vert {h}_{m} ( k ) \vert}^{2} + \frac{2}{M} {\sum }_{m = 1}^{M} {\sum }_{n = m + 1}^{M} \vert {h}_{m} ( k ) \vert \vert {h}_{n} ( k ) \vert \vert cos ( Δ {θ}_{mn} ) \vert ] , & ( 23 ) \\ = {γ}_{0} \cdot ( {g}_{c} + {g}_{b} ) , & ( 24 )\end{matrix}$$

where

$${γ}_{0} = \frac{{E}_{s}}{{N}_{0}}$$

is the SNR without diversity, and the diversity gains g_{c} and g_{b} are given in equations (17) and (22), respectively.

Complexity Analysis

As described above, the method according to the invention determines feedback information for each transmit antenna separately. Therefore, the computation complexity increases only linearly with the number of transmit antennas. However, for the optimum quantized feedback TxAA method, the computational complexity increases exponentially with the number of transmit antennas. For systems with M=4 transmit antennas and two bits representation of each element of the space encoding vector pₖ, there are totally 2^{2×(4-1)}=64 possible values of pₖ. This means that a receiver employing optimum quantized feedback must compute pₖhₖhₖ^{H}pₖ^{H} for all the 64 possible vectors of pₖ before the feedback information can be sent, and each computation of the cost function pₖhₖhₖ^{H}pₖ^{H} involves approximately 4²=16 COMPLEX multiplications. However, our sub-optimum method requires only M−1=3 computations for all the antennas, and each operation involves approximately 2 REAL multiplications. Therefore, the computational complexity of our method is only (2×3)/(64×16×2)=0.3% of the prior art optimum quantized feedback TxAA for system with M=4 transmit antennas. For system with more transmit antennas, even larger computational complexity saving can be achieved by our method.

Combining Orthogonal STBC with Group Space Encoding

The method described above only involves the encoding process in the space domain. To further reduce the amount of feedback and computation, the quadrant phase constraining feedback scheme is combined with orthogonal space-time block coding (STBC). In this method, the time domain is also utilized in the encoding process.

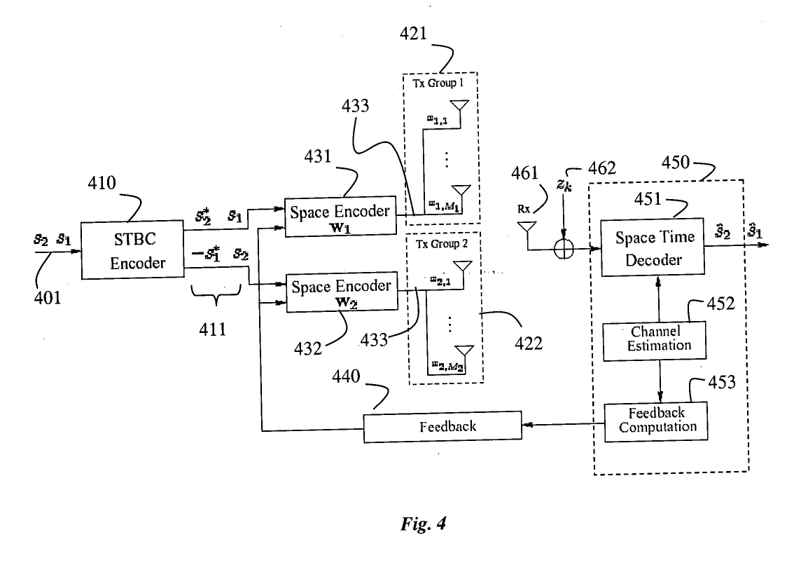

The system structure is shown in FIG. 4. Input symbols 401 are generated and modulated by conventional means. The symbols are fed into an orthogonal STBC encoder 410. Without loss of generality, we assume that at two consecutive symbol periods t₁ and t₂, an input to the STBC encoder is s₁ and s₂, respectively, where sⱼεS, for j=1,2, with S being the modulation symbol set.

The energy of the modulation symbol is E(|sⱼ|²)=Eₛ. At the STBC encoder, the input data symbols s₁ and s₂ are demultiplexed into multiple data streams, one for each group of transmit antennas. The data stream 411 of the STBC encoder 410 is expressed by
d₁=[d₁₁d₂₁]^{T}=[s₁s₂*]^{T}εC^{2×1},
d₂=[d₁₂d₂₂]^{T}=[s₂−s₁*]^{T}εC^{2×1}, (25)
where dₖ corresponds to the k^{th} output stream of the STBC encoder, with dₖⱼ being transmitted at the time instant tⱼ, and (•)^{T} denotes matrix transpose.

The M transmit antennas are divided into multiple groups of transmit antennas 421-422. Each group corresponds to one of the data streams d₁, d₂ produced by the STBC encoder 410. We assume the number of antennas contained in the k th group is Mₖ, for k=1, 2, with M₁+M₂=M.

Adaptive linear space encoders 431-432 are applied to each data stream 411 for each group of transmit antennas. The space encoders 431-432 map the multiple data streams 411 to the groups of transmit antennas according to channel feedback information 440 for each group.

If we define a space encoding vector of the k^{th} group as
pₖ=[p_{k,1}p_{k,2} . . . p_{k,M}_{ₖ}]εC^{1×M}^{ₖ}, for k=1, 2, (26)
with the constraint p₁p₁^{H}+p₂p₂^{H}=1, then encoded signals 433 to be transmitted by the k^{th} antenna group can be expressed in matrix format
Xₖ=dₖ·pₖεC^{2×M}^{ₖ}, for k=1, 2, (27)
with the symbols on the first row of Xᵢ transmitted at the symbol period t₁ and symbols on the second row transmitted at t₂.

In the channel, the received signals 461 are corrupted by both time-varying mulitpath fading and AWGN 462.

A receiver 450 includes a space-time decoder 451, a channel estimation module 452, and a feedback computation unit 453 for generating the feedback information 440 for each group of transmit antennas. The signals Rx 461 received by the receiver 450 are the sum of the propogational signals from all the transmit antennas plus the noise 462. The received signals can be represented by

$$\begin{matrix}r = [ {X}_{1} {X}_{2} ] [ \begin{matrix}{h}_{1} \\ {h}_{2}\end{matrix} ] + z , \\ = {d}_{1} {p}_{1} {h}_{1} + {d}_{2} {p}_{2} {h}_{2} + z ,\end{matrix} \qquad ( 28 )$$

where r=[r₁,r₂]^{T}, z=[z₁,z₂]^{T} are the receive vector and AWGN noise vector, respectively, with rₖ and zₖ corresponding to the time instant tₖ, hₖεC^{M}^{ₖ}^{×1} is the channel impulse response (CIR) defined as
hₖ=h_{k,1}h_{k,2} . . . h_{k,M}_{ₖ}]^{T}, for k=1, 2, (29)
with the element h_{k,m}, for m=1, 2, . . . , Mₖ, being the CIR between the m^{th} transmit antenna of group k and the receive antenna.

Combining Equations (1) and (5), we can rewrite the input-output relationship of the diversity system as

$$\begin{matrix}[ \begin{matrix}{r}_{1} \\ {r}_{2}^{*}\end{matrix} ] = [ \begin{matrix}{p}_{1} {h}_{1} & {p}_{2} {h}_{2} \\ - {h}_{2}^{H} {p}_{1}^{H} & {h}_{1}^{H} {p}_{1}^{H}\end{matrix} ] [ \begin{matrix}{s}_{1} \\ {s}_{2}\end{matrix} ] + [ \begin{matrix}{z}_{1} \\ {z}_{2}^{*}\end{matrix} ] , \\ = H \cdot s + z ,\end{matrix} \qquad ( 30 )$$

where (•)* denotes complex conjugate, s=[s₁ s₂]^{T} is the signal vector, and the channel matrix H is defined as

$$H = [ \begin{matrix}{p}_{1} {h}_{1} & {p}_{2} {h}_{2} ( 12 ) \\ - {h}_{2}^{H} {p}_{1}^{H} & {h}_{1}^{H} {p}_{1}^{H}\end{matrix} ] ∈ {C}^{2 \times 2} . \qquad ( 31 )$$

The matrix H is an 2×2 orthogonal matrix, i.e., H^{H}H═(|h₁w₁|²+|h₂w₂|²)·I₂, with I₂ being a 2×2 identity matrix. From Equations (11) and (13), we can determine the decision vector y=[y₁, y₂]^{T} as y=H^{H}r,
=(|h₁p₁|²+|h₂p₂|²)·s+v, (32)
where v=H^{H}z is the noise component with covariance matrix
i. (|h₁p₁|²+|h₂p₂|²)I₂·N₀, and N₀=E(|zₖ|²)

With the decision variable given in Equation (14), we can compute the signal to noise ratio at the receiver as follows
γ=(|h₁p₁|²+|h₂p₂|²)·γ₀, (33)
where

$${γ}_{0} = \frac{{E}_{s}}{{N}_{0}}$$

is the SNR without diversity. It can be seen from Equation (15) that the SNR γ is a function of the space encoding vectors p₁, p₂ and the CIR vectors h₁, h₂.

By selecting appropriate forms of pₖ, based on the properties of the fading channels, we can improve the receiver SNR with only a small amount of feedback information 440.

In our method, we apply the quadrant phase constraining feedback method in the design of the group space encoding vector pₖ to save both the computational complexity and feedback amount. These details are described below.

Space Encoding Vector Design: General Case

To achieve the maximum SNR at the receiver, the optimum design criterion for the space encoding vectors w₁ and w₂ is

$$( {p}_{1} , {p}_{2} ) = {argmax}_{( {p}_{1} , {p}_{2} ) ∈ W} {\vert {h}_{1} {p}_{1} \vert}^{2} + {\vert {h}_{2} {p}_{2} \vert}^{2} , \qquad ( 34 )$$

where W is the set of all the possible encoding vector pairs with the constraint p₁p₁^{H}+p₂p₂^{H}=1. The optimum values of p₁ and p₂ can be obtained by exhaustive search of all the elements of W. The size of the set W increases exponentially with the number of transmit antennas, therefore this optimum space encoding vector design method is inappropriate for systems with large number of transmit antennas.

In order to reduce the computational complexity, as well as to reduce the amount of feedback information, we apply the quadrant phase constraining method for the computation of the feedback information and the formulation of the adaptive space encoding vectors.

For a general system with M transmit antennas, we let

$${M}_{1} = {M}_{2} = \frac{M}{2}$$

when M is an even number, and

$${M}_{1} = \frac{M + 1}{2} , {M}_{2} = \frac{M - 1}{2}$$

when M is an odd number. We define the space encoding vector pₖ as

$${p}_{k} = \frac{1}{\sqrt{M}} [ 1 exp ( - i \cdot {q}_{k , 2} \frac{π}{2} ) … exp ( - i \cdot {q}_{k , {M}_{k}} \frac{π}{2} ) ] ∈ {C}^{1 \times {M}_{k}} , for k = 1 , 2 , \qquad ( 35 )$$

where i²=−1 is the imaginary part symbol, q_{k,m}ε{0, 1, 2, 3}, for m=2, 3, . . . , Mₖ and k=1, 2, is the feedback information, and each q_{k,m} contains two bits of information. For systems with M transmit antennas, the total number of feedback bits required by our method is 2M−4. For convenience of representation, we let q_{1,1}=q_{2,1}=0.

Applying the quadrant phase constraining method, we can compute the feedback information q_{k,m} as

$${q}_{k , m} = \{ \begin{matrix}⌊ \frac{{\tilde{θ}}_{m , k} + π / 4}{π / 2} ⌋ , & {\tilde{θ}}_{k , m} ∈ [ \frac{π}{4} , \frac{7 π}{4} ) , ( 24 ) \\ 0 , & otherwise\end{matrix} , \qquad ( 36 )$$

where └ [symbol] ┘ returns the nearest smaller integer, and
\tilde{θ}_{k,m}=θ_{k,m}−θ_{k,1}+2lπ, (37)
with the integer l selected such that \tilde{θ}_{k,m} is in the range of [0, 2π).

With the adaptive diversity algorithm described here, 2M−4 bits of feedback information are required to form the space encoding vectors for systems with M transmit antennas. It will be shown next that the amount of feedback information can be further reduced for systems with M=4 or M=3 transmit antennas, which are of practical interests of next generation communication systems.

Space Encoding Vector Design: Special Case

For systems with M≦4 transmit antennas, each group has two transmit antennas at most. For groups with two transmit antennas, our sub-optimum design criterion can be satisfied with only one bit of feedback information.

For a systems with M=4 transmit antennas, the number of antennas in each of the antenna groups is M₁=M₂=2. We define the space encoding vector as

$${p}_{k} = \frac{1}{2} [ 1 {( - 1 )}^{{b}_{k}} ] , for k = 1 , 2 , \qquad ( 38 )$$

where bₖε{0,1} is the feedback information for the k^{th} antenna group. The feedback information can be defined by

$${b}_{k} = \{ \begin{matrix}0 , & ℛ ( {h }_{k , 1} {{h}^{*}}_{k , 2} ) \geq 0 , \\ 1 , & otherwise\end{matrix} \qquad ( 39 )$$

The SNR at the receiver is expressed by
γ₄=(g_{4,c}+g_{4,b})γ₀, (40)
with the conventional diversity gain g_{4,c} and the feedback diversity gain g_{4,b} defined as

$$\begin{matrix}{g}_{4 , c} = \frac{1}{4} ( {\sum }_{m = 1}^{2} {\vert {h}_{1 , m} \vert}^{2} + {\sum }_{m = 1}^{2} \vert {h}_{2 , m} {\vert}^{2} ) , & ( 41 ) \\ {g}_{4 , b} = \frac{1}{2} {\sum }_{k = 1}^{2} \vert ℛ ( {h}_{k , 1} {h}_{k , 2}^{*} ) \vert . & ( 42 )\end{matrix}$$

Similarly, for systems with M=3 antennas, we have groups M₁=2 and M₂=1. Because there is only one antenna in the second group, we have p₂=1/\sqrt{3}.

For the first group with two transmit antennas, we apply the space encoding vector p₁. With this encoding scheme, the receiver SNR can be computed from Equation (15) as
γ₃=(g_{3,c}+g_{3,b})·γ₀, (43)
with the conventional diversity gain g_{3,c} and feedback diversity gain g_{3,b} given by

$$\begin{matrix}{g}_{3 , c} = \frac{1}{3} ( {\sum }_{m = 1}^{2} \vert {h}_{1 , m} {\vert}^{2} + \vert {h}_{2 , 1} {\vert}^{2} ) , & ( 44 ) \\ {g}_{3 , b} = \frac{2}{3} \vert ( {h}_{k , 1} {h}_{k , 2}^{*} ) \vert . & ( 45 )\end{matrix}$$

When there are only two transmit antennas in the system, we have w₁=w₂=1/\sqrt{2}, and this scheme is reduced to orthogonal space time block coding described above.

With our method, we only need one bit and two bits of feedback information for systems with M=3 and M=4 transmit antennas, respectively.

Performance Bounds

Based on the statistical properties of the output signal 105 at the receiver 20, the theoretical performance bounds of our diversity scheme as

$$\begin{matrix}{P}^{U} ( E ) = \frac{1}{π} {\int }_{0}^{\frac{π}{2}} {\prod }_{m = 1}^{M} {( 1 + \frac{{\overline{γ}}_{m}}{{sin}^{2} θ} )}^{- 1} ⅆ θ , & ( 46 ) \\ {P}^{L} ( E ) = \frac{1}{2} - \frac{1}{π} {\int }_{0}^{π l2} \frac{exp ( - tan θ )}{sin 2 θ} 𝔍 \{ ϕ ( 2 \sqrt{tan θ} ) \} ⅆ θ . & ( 47 )\end{matrix}$$

Here, the derivations of P^{U}(E) and P^{L}(E) are omitted for the purpose of clarity. With the theoretical performance bounds given in equation (46) and (47), the actual error probability P(E) of our diversity scheme satisfies
P^{U}(E)≧P(E)≧P^{L}(E). (48)

Equations (46-48) evaluate the method according to the invention on a theoretical basis, and these equations can be used as a guide for designing wireless communication systems.

It should be noted that the conventional full-rate STBC and close loop technique based on the orthogonal STBC can only be implemented for systems with exactly two transmit antennas.

In contrast, the transmit diversity method according to the invention can be used for systems with an arbitrary number of transmit antennas. This is extremely useful for a high speed downlink data transmission of next generation wireless communication systems, where higher diversity orders are required to guarantee high data throughput in the downlink with multiple transmit antennas and one receive antenna.

Effect of the Invention

The method according to the invention outperforms conventional orthogonal STBC by up to 2 dB. The performance of the version with two bits of feedback information is approximately 0.4 dB better than the version with one bit of feedback information.

The prior art full rate STTD and ASTTD systems can be implemented for systems with at most two transmit antennas. In contrast, our transmit diversity method can be used for systems with an arbitrary number of transmit antennas. Furthermore, the performance of the method improves substantially linearly with the increasing number of transmit antennas.

Our method is very computationally efficient compared to the prior art optimum quantized method. Our method requires only 0.3% computation efforts of the prior art optimum quantized feedback TxAA for systems with 4 transmit antennas. This computation saving is significant at the receiver, which is usually a battery powered cellular phone.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

1. A method for improving transmit diversity gain in a wireless communication system including a transmitter with a plurality of transmit antennas and a receiver with one receive antenna, comprising:
partitioning the plurality of transmit antennas into a plurality of groups of transmit antennas;
measuring, in the receiver, a phase of a channel impulse response for each transmit antenna;
determining, independently, feedback information for each group of transmit antennas from the channel impulse responses;
sending the feedback information for each group of transmit antennas to the transmitter;
orthogonal space-time block encode input symbols in the transmitter to produce a data stream for each group of transmit antennas; and
adaptive linear space encoding each data stream according to the feedback information for the group to produce an encoded signal for each transmit antenna of each group.

2. The method of claim 1, wherein the determining further comprises:
selecting one of the channel impulse responses as a reference channel impulse response; and
normalizing the measured phase according to a phase of the reference channel impulse response so that a normalized phase is in a quadrant phase sector of the reference phase.

3. The method of claim 2, in which the reference channel impulse response has a highest power.

4. The method of claim 2, in which the quadrant phase sector spans ninety degrees.

5. The method of claim 2, in which the normalization rotates the phase, and the feedback information encodes an amount of rotation.

6. The method of claim 1, in which there are four transmit antennas, and each group has two transmit antennas and the feedback information is one bit for each group.

7. A wireless communication system, comprising:
a transmitter comprising:
a plurality of groups of transmit antennas;
means for generating input symbols;
an orthogonal space-time block encoder configured to produce a data stream for each group of transmit antennas;
an adaptive linear space encoder configured to produce an encoded signal for each transmit antenna of each group from the data stream for the group according to feedback information for the group; and
a transmitter, comprising:
a single receive antenna;
means for measuring a phase of a channel impulse response for each transmit antenna;
means for determining independently the feedback information for each group of transmit antennas from the channel impulse responses;
means for sending the feedback information for each group of transmit antennas to the transmitter.
